(19) United States
(12) Patent Application Publication
(10) Pub. No.: US 2010/0250405 A1
(43) Pub. Date: Sep. 30, 2010

(54) METHOD, SYSTEM AND PROGRAM PRODUCT FOR IDENTIFYING REDUNDANT INVOICES

(75) Inventors: David V. DeWitt, Vestal, NY (US); Anthony T. Mazzatti, Johnson City, NY (US); Scotty J. Reynolds, Owego, NY (US); Jason P. Sladish, Endicott, NY (US)

Correspondence Address: Law Office of Jim Boice, 3839 Bee Cave Road, Suite 201, West Lake Hills, TX, 78746, US

(73) Assignee: International Business Machines Corporation, Armonk, NY (US)

(21) Appl. No.: 12/413,391

(22) Filed: Mar. 27, 2009

(51) Int. Cl. G06Q 90/00

(52) U.S. Cl. 705/30

(57) ABSTRACT

A method, system and program product for identifying redundant invoices. The method includes providing an accounts payable system having an invoice table that contains invoice data inputted from vendor invoices, executing an algorithm with the accounts payable system for identifying one or more redundant invoices among a current group of invoices chosen from the invoices inputted into the accounts payable system, where the algorithm identifies the redundant invoices among the current group of invoices using each of six redundancy criteria analyzed by the algorithm and outputting a perceptible report containing a separate section corresponding to each of the six redundancy criteria analyzed by the algorithm for identifying redundant invoices among the current group of invoices inputted into the accounts payable system, where a redundant invoice that is reported in one section of the perceptible report is not reported in another section of the perceptible report.

### FIELD OF THE INVENTION

The present invention relates to a method, system and program product for identifying redundant vendor or supplier invoices entered into an accounts payable electronic computer system.

### BACKGROUND OF THE INVENTION

Organizations/corporations process numerous vendor/supplier invoices on a daily basis. As such, whenever there is an invoice that has already been processed or entered into an organization's accounts payable system, the process of identifying whether or not an invoice is a duplicate invoice can be manually intensive in that some person needs to go through and analyze each invoice and needs to take the appropriate steps to correct the problem in the organization's invoice processing system. Thus, it has become imperative that organizations/corporations examine the resources needed to manually process such duplicate vendor/supplier invoices in order to improve efficiency and to facilitate the identification of duplicate vendor/supplier invoices.

### SUMMARY OF THE INVENTION

The present invention resides in a method, system and program product for identifying redundant invoices. In one aspect of the invention, the invention provides a method for identifying redundant invoices. The method includes providing an accounts payable system having an invoice table that contains invoice data inputted from vendor invoices, executing an algorithm with the accounts payable system for identifying one or more redundant invoices among a current group of invoices chosen from the invoices inputted into the accounts payable system, where the algorithm identifies the redundant invoices among the current group of invoices using each of six redundancy criteria analyzed by the algorithm and outputting a perceptible report containing a separate section corresponding to each of the six redundancy criteria analyzed by the algorithm for identifying redundant invoices among the current group of invoices inputted into the accounts payable system, where a redundant invoice that is reported in one section of the perceptible report is not reported in another section of the perceptible report. In an embodiment, the providing step further comprises selecting a history start date and a current start date for choosing the current group of invoices from the plurality of invoices inputted, grouping, as a group, suppliers having a similar name and creating additional indexes for sorting the invoice data contained in the invoice table in the accounts payable electronic computer system. In an embodiment, the executing step includes loading the algorithm onto the accounts payable electronic computer system and executing the algorithm on the accounts payable electronic computer system in real time. In an embodiment, the executing step includes loading the algorithm onto the accounts payable electronic computer system and executing the algorithm on the accounts payable electronic computer system in batch mode. In an embodiment, the six redundancy criteria analyzed by the algorithm for searching the accounts payable electronic computer system includes same supplier invoice number and same amount, supplier reference numbers containing a reference number as a subset, redundant condensed supplier reference numbers, transposed supplier reference numbers and same supplier invoice number, invoice date and amount, with a different supplier number.

In another aspect of the invention, the invention provides a computer system for identifying redundant invoices. The computer system includes a central processing unit, first program instructions to input a plurality of invoices into an accounts payable electronic computer system, the first program instructions including instructions to group, as a group, invoices that have a similar vendor name, second program instructions to execute an algorithm on the accounts payable electronic computer system for identifying one or more redundant invoices among a current group of invoices chosen from the plurality of invoices inputted into the accounts payable electronic computer system, In an embodiment, the algorithm identifies the one or more redundant invoices among the plurality of invoices using each of six redundancy criteria searched by the algorithm and third program instructions to output a perceptible report containing respective separate sections corresponding to each of the six redundancy criteria analyzed by the algorithm for identifying the one or more redundant invoices among the current group of invoices inputted into the accounts payable electronic computer system, In an embodiment, an invoice reported on a respective section is not reported on another respective section of the perceptible report. In an embodiment, the first program instructions include instructions to load the algorithm onto the accounts payable electronic computer system, to select a history start date and a current start date for choosing the current group of invoices from the plurality of invoices inputted, to group, as a group, suppliers having a similar name and to create additional indexes for sorting the invoice data contained in the invoice table in the accounts payable electronic computer system. In an embodiment, the second program instructions include instructions to execute the algorithm on the accounts payable electronic computer system in real time. In an embodiment, the second program instructions include instructions to execute the algorithm on the accounts payable electronic computer system in batch mode. In an embodiment, the six redundancy criteria analyzed by the algorithm for searching the accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.

In another aspect of the invention, the invention provides a computer program product for identifying redundant invoices. The computer program product includes a computer readable medium, first program instructions to input data from a plurality of invoices into an invoice table residing within an accounts payable electronic computer system, second program instructions to execute an algorithm loaded onto the accounts payable electronic computer system for identifying one or more redundant invoices among a current group chosen from the plurality of invoices inputted into the accounts payable electronic computer system, In an embodiment, the algorithm identifies the redundant invoices among the current group of invoices chosen from the plurality of invoices using each of six redundancy criteria searched by the algorithm and third program instructions to output a perceptible report containing a separate section corresponding to each of the six redundancy criteria analyzed by the algorithm for identifying the one or more redundant invoices among the current group of invoices inputted into the accounts payable electronic computer system, In an embodiment, a redundant invoice that is reported in one section of the perceptible report is not reported in another section of the perceptible report and In an embodiment, the first, second and third program instructions are recorded on the computer readable medium. In an embodiment, the first program instructions include instructions to load the algorithm onto the accounts payable electronic computer system, to select a history start date and a current start date for choosing the current group of invoices from the plurality of invoices inputted, to group, as a group, suppliers having a similar name and to create additional indexes for sorting the invoice data contained in the invoice table in the accounts payable electronic computer system. In an embodiment, the second program instructions include instructions to execute the algorithm on the accounts payable electronic computer system in real time. In an embodiment, the second program instructions include instructions to execute the algorithm on the accounts payable electronic computer system in batch mode. In an embodiment, the six redundancy criteria analyzed by the algorithm for searching the accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.

In yet another aspect of the invention, the invention provides a process for deploying computing infrastructure comprising integrating computer-readable code into a computing system, where the code in combination with the computing system is capable of performing a process for identifying redundant invoices. The process comprises providing an accounts payable electronic computer system, inputting, invoice data obtained from a plurality of invoices, into an invoice table residing on the accounts payable electronic computer system, executing an algorithm on the accounts payable electronic computer system for identifying one or more redundant invoices among a current group of invoices chosen from the plurality of invoices inputted into the accounts payable electronic computer system, where the algorithm identifies the redundant invoices among the current group of invoices chosen from the plurality of invoices using each of six redundancy criteria searched by the algorithm and outputting a perceptible report containing a separate section corresponding to each of the six redundancy criteria analyzed by the algorithm for identifying the one or more redundant invoices inputted into the accounts payable electronic computer system, In an embodiment, a redundant invoice that is reported in one section of the perceptible report is not reported in another section of the perceptible report.

A process for deploying computing infrastructure comprising integrating computer-readable code into a computing system, wherein the code in combination with the computing system is capable of performing a process for identifying redundant invoices. The process includes providing an accounts payable electronic computer system, inputting, invoice data obtained from a plurality of invoices, into an invoice table residing on the accounts payable electronic computer system, executing an algorithm on the accounts payable electronic computer system for identifying one or more redundant invoices among a current group of invoices chosen from the plurality of invoices inputted into the accounts payable electronic computer system, In an embodiment, the algorithm identifies the redundant invoices among the current group of invoices chosen from the plurality of invoices using each of six redundancy criteria searched by the algorithm and outputting a perceptible report containing a separate section corresponding to each of the six redundancy criteria analyzed by the algorithm for identifying the one or more redundant invoices inputted into the accounts payable electronic computer system, In an embodiment, a redundant invoice that is reported in one section of the perceptible report is not reported in another section of the perceptible report. In an embodiment, the providing step includes selecting a history start date and a current start date for choosing the current group of invoices from the plurality of invoices inputted, grouping, in a group, suppliers having a similar name and creating additional indexes for sorting the invoice data contained in the invoice table in the accounts payable electronic computer system. In an embodiment, the executing step includes loading the algorithm onto the accounts payable electronic computer system and executing the algorithm on the accounts payable electronic computer system in real time. In an embodiment, the executing step includes loading the algorithm onto the accounts payable electronic computer system and executing the algorithm on the accounts payable electronic computer system in batch mode. In an embodiment, the six redundancy criteria analyzed by the algorithm for searching the accounts payable electronic computer system consists of: same supplier invoice number and same amount, supplier reference numbers containing a reference number as a subset, redundant condensed supplier reference numbers, transposed supplier reference numbers and same supplier invoice number, invoice date and amount, with a different supplier number. In an embodiment, each of the first, second and third program instructions are stored on the computer system for execution by the central processing unit.

### BRIEF DESCRIPTION OF THE DRAWINGS

The accompanying drawings which are incorporated in and form a part of this specification, illustrate embodiments of the invention and, together with the description, serve to explain the principles of the invention:

FIG. 1 is a flowchart depicting a method of processing vendor/supplier invoices, in accordance with an embodiment of the present invention.

FIG. 2 is a flowchart depicting a method for identifying redundant invoices entered into an accounts payable electronic computer system, in accordance with an embodiment of the present invention.

FIG. 3 is a flowchart depicting a method for identifying redundant invoices entered into an accounts payable electronic computer system, in accordance with an embodiment of the present invention.

FIG. 4 is a flowchart depicting a method for verifying redundant invoices identified on a redundant report outputted by the redundant invoice reporting tool or program executed on the accounts payable electronic computer system, in accordance with an embodiment of the present invention.

FIG. 5 depicts an embodiment of a computer system having deployed thereon a redundant invoice reporting tool for identifying redundant invoices entered into an accounts payable electronic computer system, in accordance with an embodiment of the present invention.

FIG. 6 depicts a computer infrastructure having deployed thereon a redundant invoice reporting tool for identifying redundant invoices entered into an accounts payable electronic computer system, in accordance with an embodiment of the present invention.

FIG. 7A-7F show an example of a redundancy report generated by the redundant invoice reporting tool that is executed on an accounts payable electronic computer system for identifying redundant invoices entered into the accounts payable electronic computer system, in accordance with embodiments of the invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Preferably, the computer systems include a plurality of hardware circuits.

Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices, over disparate memory devices and may exist, at least partially, merely as electronic signals on a system or network.

Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the present invention provides a method or process of identifying redundant invoices entered into an accounts payable electronic (AP or A/P) computer system, such as, an ERP (Enterprise Resource Planning) system, for instance, the commercially available SAP® Accounts Payable software application module, manufactured by SAP Aktiengesellschaft Joint Stock Company. As used herein, the term “invoice” refers to a respective vendor invoice entered into the accounts payable electronic computer system and which contains data fields obtained from a respective paper or electronic invoice, such as, supplier or vendor name, dollar amount of the invoice, invoice date, invoice reference number, among other data fields found on the paper or electronic invoice. The method or process of identifying redundant invoices includes providing an accounts payable electronic computer system, such as, an ERP system or SAP® Accounts Payable system that has a master database for inputting a plurality of vendor/supplier invoices proffered by respective vendors/suppliers. In a preferred embodiment, the invoices represent paper invoice articles from vendors or suppliers to a customer. It will be understood by one skilled in the art that although the invention is described in terms of use with an ERP system, such as, the SAP® system, the invention may be used with any other commercially available ERP system.

In an embodiment, the invention provides a method for identifying redundant invoices. The method includes providing an accounts payable system having an invoice table that contains invoice data inputted from vendor invoices, executing an algorithm with the accounts payable system for identifying one or more redundant invoices among a current group of invoices chosen from the invoices inputted into the accounts payable system, where the algorithm identifies the redundant invoices among the current group of invoices using each of six redundancy criteria analyzed by the algorithm and outputting a perceptible report containing a separate section corresponding to each of the six redundancy criteria analyzed by the algorithm for identifying redundant invoices among the current group of invoices inputted into the accounts payable system, where a redundant invoice that is reported in one section of the perceptible report is not reported in another section of the perceptible report. In an embodiment, the providing step further comprises selecting a history start date and a current start date for choosing the current group of invoices from the plurality of invoices inputted, grouping, as a group, suppliers having a similar name and creating additional indexes for sorting the invoice data contained in the invoice table in the accounts payable electronic computer system. In an embodiment, the executing step includes loading the algorithm onto the accounts payable electronic computer system and executing the algorithm on the accounts payable electronic computer system in real time. In an embodiment, the executing step includes loading the algorithm onto the accounts payable electronic computer system and executing the algorithm on the accounts payable electronic computer system in batch mode. In an embodiment, the six redundancy criteria analyzed by the algorithm for searching the accounts payable electronic computer system include same supplier invoice number and same amount, supplier reference numbers containing a reference number as a subset, redundant condensed supplier reference numbers, transposed supplier reference numbers and same supplier invoice number, invoice date and amount, with a different supplier number. In an embodiment, the six redundancy criteria analyzed by the algorithm for searching the accounts payable electronic computer system consists essentially of same supplier invoice number and same amount, supplier reference numbers containing a reference number as a subset, redundant condensed supplier reference numbers, transposed supplier reference numbers and same supplier invoice number, invoice date and amount, with a different supplier number.

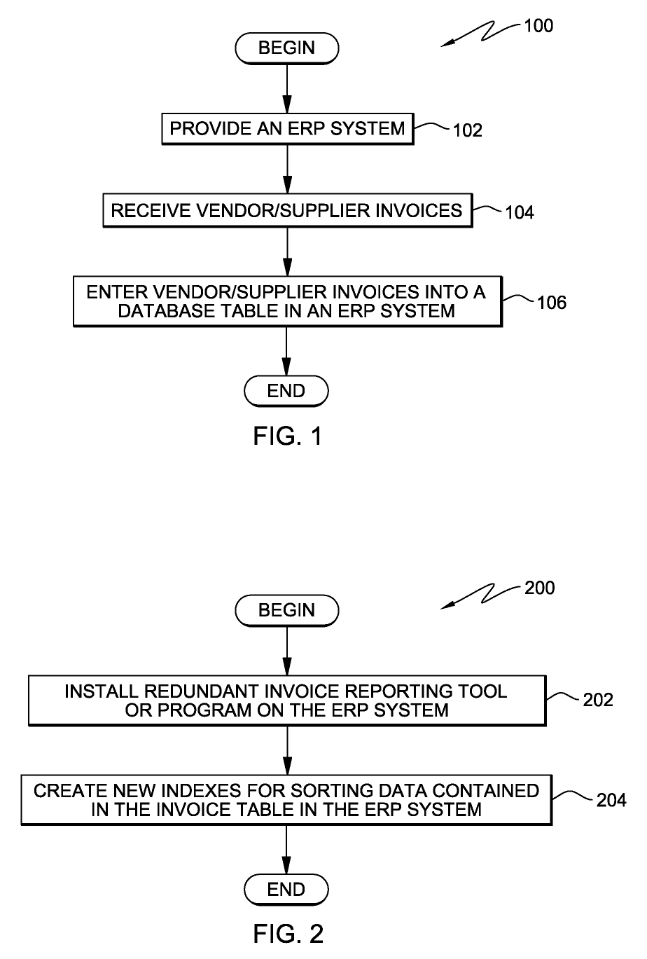

Reference is now made to FIG. 1, reference numeral 100, which depicts a flowchart showing a method of processing vendor/supplier invoices, in accordance with an embodiment of the present invention. The method of processing vendor or supplier invoices begins by providing (in step 102) an accounts payable electronic computer system, such as, an ERP (Enterprise Resource Planning) system or SAP® Accounts Payable system that includes a master database for inputting a plurality of vendor/supplier invoices proffered by respective vendors/suppliers. The vendor or supplier invoices are received in step 104. The vendor or supplier invoices are preferably either paper invoices or electronic invoices that are received by an organization or company. The data (also referred to herein as “invoice data”) contained in the vendor or supplier invoices is entered in step 106 into a database table or invoice table or data table or referred to as the BSIP table in the ERP or SAP® system, ending the method for processing invoices.

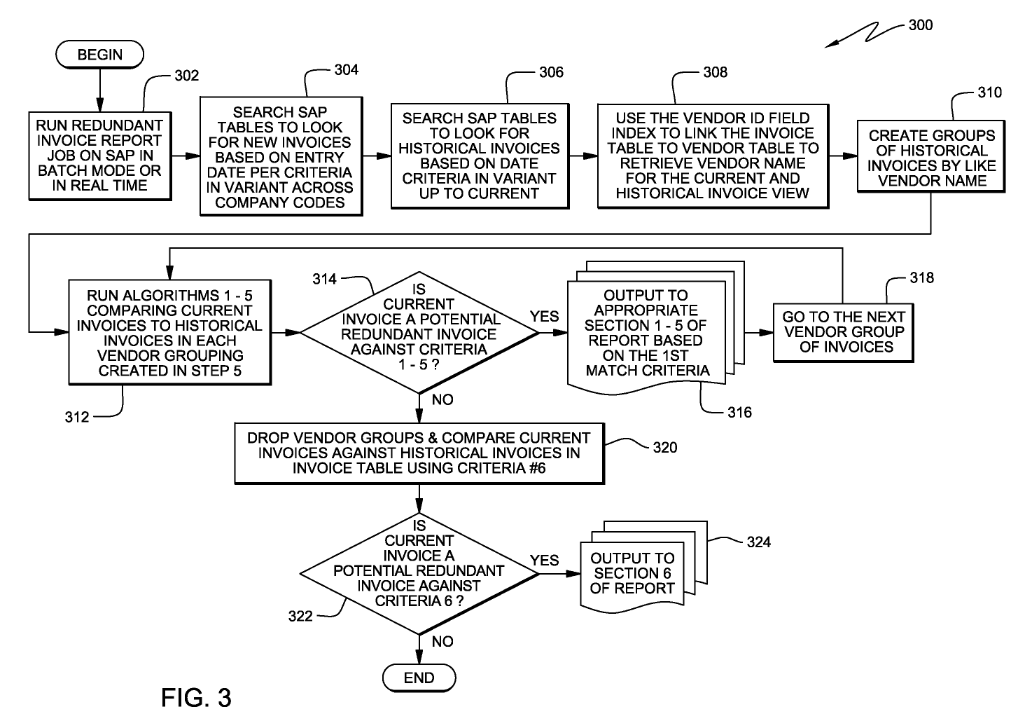

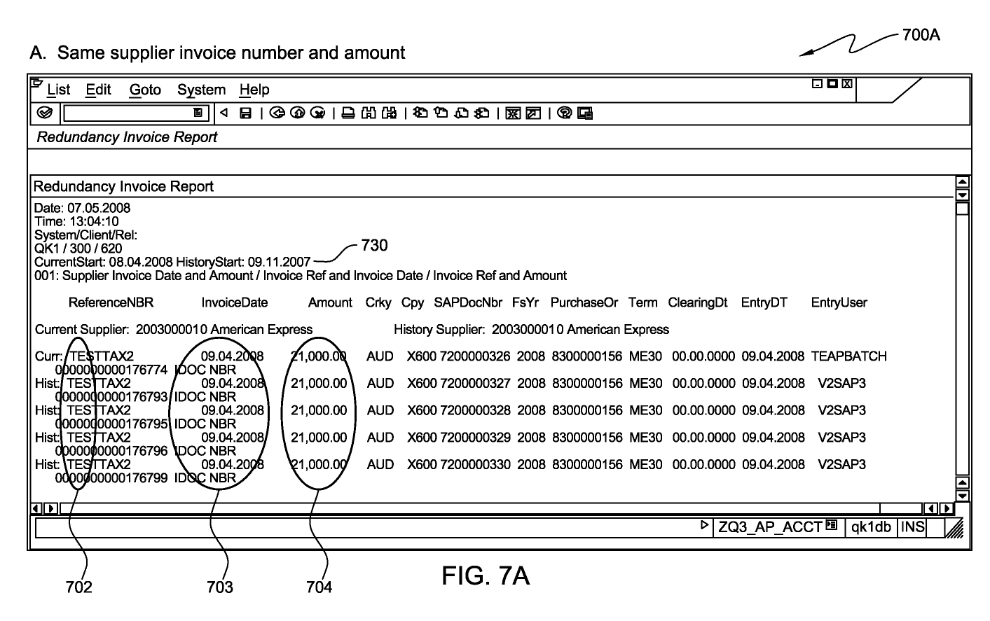

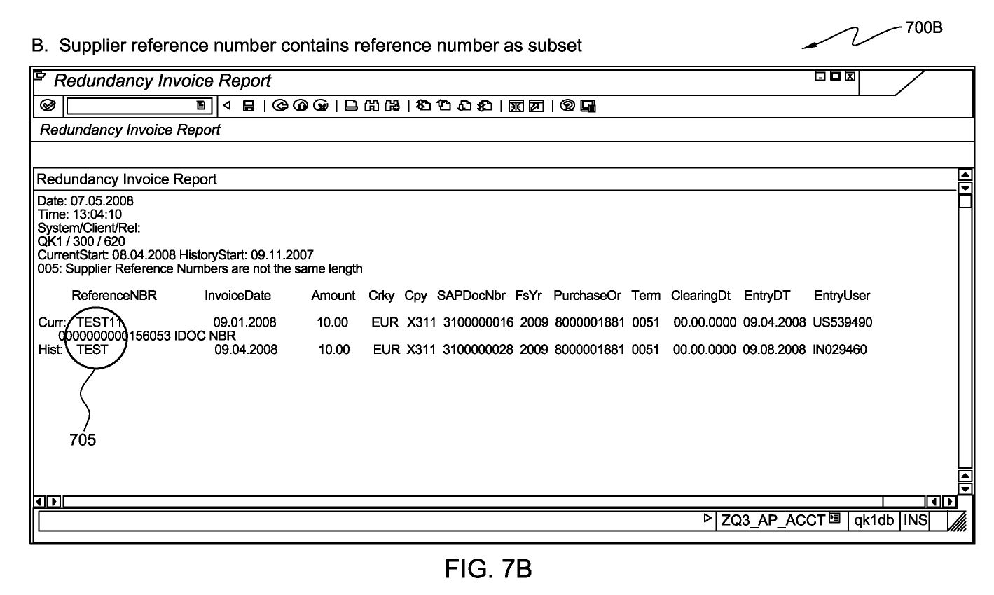

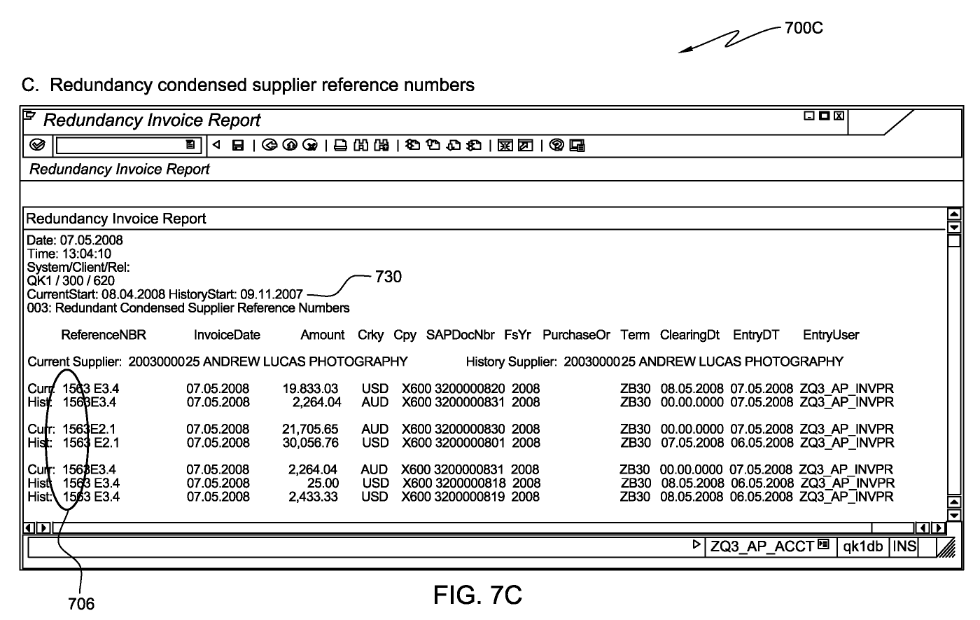

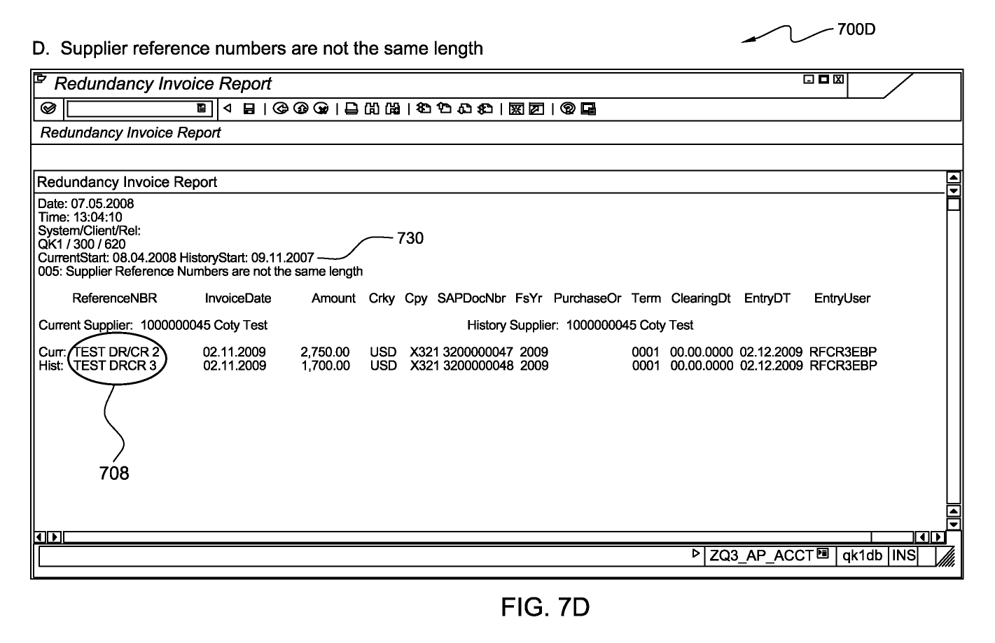

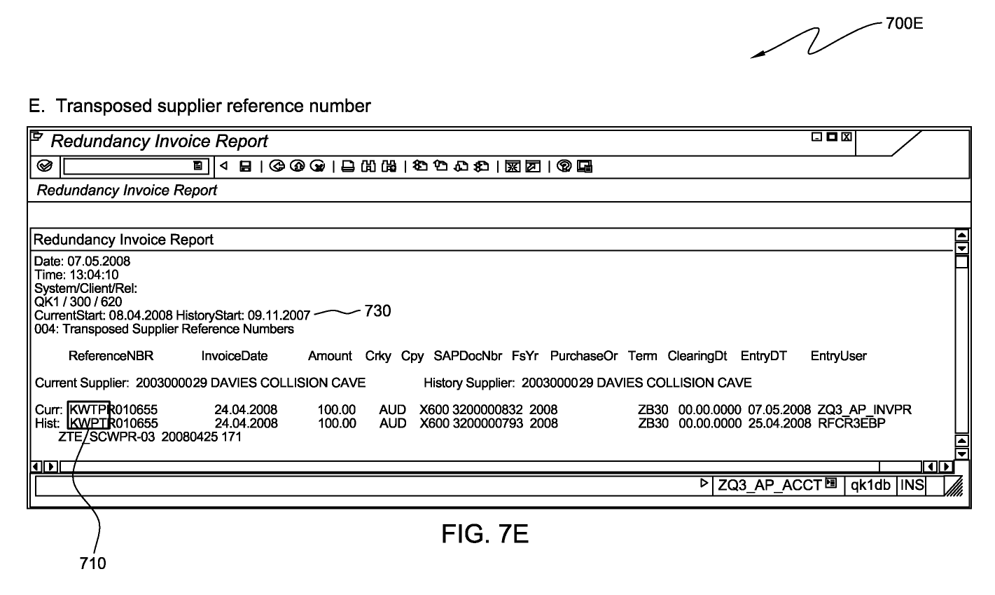

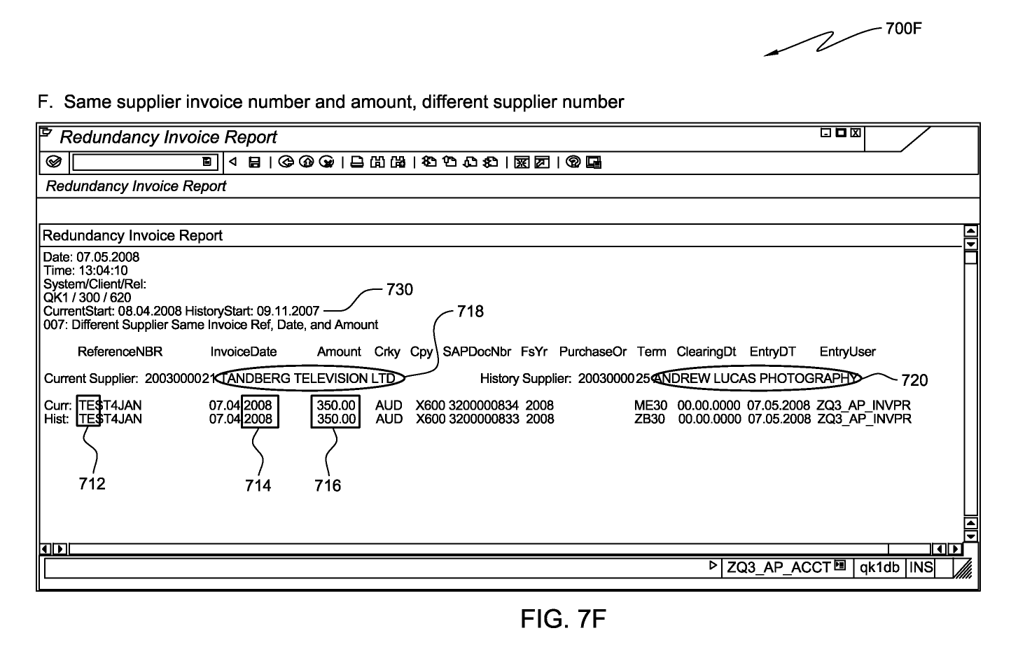

Turning to FIG. 2, reference numeral 200, depicts a flowchart showing one aspect of the steps involved in identifying redundant invoices entered into an accounts payable electronic computer system, in accordance with an embodiment of the present invention. In step 202, the redundant invoice reporting tool or program is installed on the ERP system or SAP® system, which includes the invoice table or data table or BSIP table that contains invoice data inputted from the vendor or supplier invoices that are received. In an embodiment, the redundant or redundancy invoice reporting tool or program searches the invoice data entered into the data invoice tables stored in the ERP or SAP® system using six redundant or redundancy criteria. In an embodiment, the first redundant criteria that the redundant invoice reporting tool or program searches for is same supplier or vendor invoice number and amount. In an embodiment, for the first redundant criteria, the redundant invoice reporting tool or program searches the invoice table for same supplier invoice date (as shown by reference numeral 703 in FIG. 7A) and amount (reference numeral 704 in FIG. 7A). Further, in an embodiment, the redundant invoice reporting tool or program searches the invoice table for same supplier invoice reference number (as shown by reference numeral 702 in FIG. 7A) and invoice date (reference numeral 703 in FIG. 7A). Furthermore, in an embodiment, the redundant invoice reporting tool or program searches the invoice table for same supplier invoice reference number (as shown by reference numeral 702 in FIG. 7A) and amount (reference numeral 704 in FIG. 7A). The second redundant criteria that the redundant invoice reporting tool or program searches for is supplier or vendor reference numbers that contain a reference number as a subset (one or more potential invoices matching this second redundancy criteria is not shown in the redundancy report in FIG. 7B). The third redundant criteria that the redundant invoice reporting tool or program searches for is redundant condensed supplier reference numbers (as shown by reference numeral 706 in FIG. 7C). The fourth redundant criteria that the redundant invoice reporting tool or program searches for is supplier or vendor reference numbers that have supplier or vendor reference numbers that do not have the same length (as shown by reference numeral 708 in FIG. 7D). The fifth redundant criteria that the redundant invoice reporting tool or program searches for is transposed supplier or vendor reference number (as shown by reference numeral 710 in FIG. 7E). The sixth redundant criteria that the redundant invoice reporting tool or program searches is for redundant invoices that have the same supplier or vendor invoice number (reference numeral 712 in FIG. 7F), date (reference numeral 714 in FIG. 7F) and amount (reference numeral 716 in FIG. 7F), even if these redundant invoices have different supplier or vendor numbers (reference numeral 718 and 720 in FIG. 7F), as explained further herein below with respect to FIG. 3. Further, in step 204, new indexes are created for sorting the data contained in the invoice table or BSIP table within the ERP or SAP system, ending the process. In an embodiment, the invoice table or BSIP table is indexed using seven fields, namely, the invoice or document date field, invoice number field, invoice amount field, vendor number field, company code field, SAP document number field and the fiscal year field. The new indexes created enable the redundant invoice reporting tool or program to find and sort the information stored in the invoice tables within the ERP system more efficiently and in a faster time frame. Further, the indexing of the vendor number or identification field (reference numeral 204) also enables the redundant invoice reporting tool or program to link the invoice table to the vendor table, such that, the invoice data can be pulled together into one searchable view.

Turning to FIG. 3, reference numeral 300, depicts a flowchart showing the method or process steps performed by an accounts payable electronic computer system having a redundant invoice reporting tool or program installed thereon for identifying potential redundant invoices entered into the accounts payable electronic computer system, in accordance with an embodiment of the present invention. The method begins with running (in step 302), a redundant invoice reporting tool or program on the ERP system or SAP® system, which includes a data table or invoice table (namely, the BSIP table) that contains invoice data entered in the ERP system SAP® system in step 102 of FIG. 1. In an embodiment, the redundant invoice reporting tool or program is run in batch mode on the ERP or SAP system, such that, a report can be outputted the next day. In another embodiment, the redundant invoice reporting tool or program is run in real time mode on the ERP or SAP system, such that, the redundant invoice reporting tool or program can flag redundant invoice s up to a specific point in time that very same day, that is, up to the point that the redundant invoice reporting tool or program is executed on the SAP system. The redundant invoice reporting tool or program in step 304 searches one or more SAP data tables to look for new invoices based on an entry date per criteria in variant across company codes. In particular, the redundant invoice reporting tool or program searches one of three tables for new invoices. The three SAP tables searched by the redundant invoice reporting tool or program are the BSIP table, the BKPF table and the BSEG table. In an embodiment, the BSIP table contains header information pertaining to an invoice. In an embodiment, the BKPF table contains payment information details pertaining to an invoice. In an embodiment, the BSEG table contains item details for an invoice. Further, the variant sets forth a history start date and a current start date (as shown by reference numeral 730 in FIGS. 7A-7F), which dictates a selection of invoices in the three SAP tables that are to be analyzed by the redundant invoice reporting tool or program. In step 306, the redundant invoice reporting tool or program searches the three SAP tables, BSIP, BKPF and BSEG within the SAP system to look for historical invoices based on date criteria in variant up to current, that is, the redundant invoice reporting tool or program searches the invoices found that fall within the history start date and the current start date range. For example, as shown in FIGS. 7A through 7F, the variant sets forth a history start date of Sep. 11, 2007 and a current start date of Aug. 4, 2008, which means that the redundant invoice reporting tool or program will investigate invoices having a date that falls between the history start date of Sep. 11, 2007 all the way to the current start date of Aug. 24, 2008, as shown in FIGS. 7A through 7F. So the redundant invoice reporting tool or program searches across these three tables (which are already indexed) using the date parameter (entry date criteria) to pull information that matches the date criteria. In step 308, the redundant invoice reporting tool or program uses a vendor or supplier id field index to link the invoice table to a vendor or supplier table that contains a listing of all the vendor or supplier names. In step 310, the redundant invoice reporting tool or program creates vendor or supplier groups for the historical invoices by grouping together like vendor or supplier names. The redundant invoice reporting tool or program runs in step 312 respective algorithms corresponding to the first five of six redundancy criteria described herein above with respect to FIG. 2, for comparing current invoices to historical invoices in each of the vendor or supplier groups created in step 310, starting with the first vendor group created in step 310. In particular, the redundant invoice reporting tool or program runs the five algorithms corresponding to the five redundant criteria, namely, same supplier or vendor invoice number and amount, supplier or vendor reference numbers that contain a reference number as a subset, redundant condensed supplier reference numbers, supplier or vendor reference numbers that do not have the same length, transposed supplier or vendor reference number. The redundant invoice reporting tool or program determines in step 314 whether or not a current invoice is a potential redundant invoice against these five redundant criteria described above. In particular, the redundant invoice reporting tool or program examines the invoice table for a match by running each of the five algorithms corresponding to the five redundant criteria mentioned above against a first vendor group created in step 310, such that the all current invoices that match respective historical invoices will be flagged by the redundant invoice reporting tool or program. In an embodiment, the redundant invoice reporting tool or program is run contemporaneously against each vendor group on the ERP or SAP system for identifying redundant invoices matching criteria 1-5 in the invoice tables. In particular, if the redundant invoice reporting tool or program investigates or performs a search on the invoice table and determines that a respective current invoice is a potential invoice matching one of these five redundancy criteria, then the redundant invoice reporting tool or program outputs to a redundancy report in step 316 the first matching invoice that is found that matches a respective first redundancy criteria. In particular, only the invoice that matches a respective redundancy criteria among the five redundancy criteria first will be outputted to an appropriate section of the redundancy report. For instance, if an invoice is a match both on criteria one and criteria three of the five redundant criteria searched, then the invoice which matches criteria one and criteria five will only be outputted to section one of the report (that is, the section matching the first criteria searched) and not to section three of the report (which is searched after criteria two, three and four) in order to minimize redundant listings in the report. In step 318, the redundant invoice reporting tool or program uses the next vendor group created in step 310 and runs in step 312 respective algorithms corresponding to the first five of the six redundancy criteria described herein above with respect to FIG. 2, for comparing current invoices to historical invoices in the next vendor or supplier group created in step 310. Steps 312 through 318 are repeated until the redundant invoice reporting tool or program runs the five algorithms against each of the vendor or supplier groups created in step 310. However, if no potential redundant invoice is found running the first five algorithms for finding invoices that match the respective redundancy or duplicative criteria, then the redundant invoice reporting tool or program drops the vendor groups and compares in step 320 the current invoices against historical invoices in search view in the BSIP table using the last or sixth redundant criteria, namely, same supplier or vendor invoice number and amount, but different supplier or vendor number. A determination is made in step 322 as to whether or not the current invoice is a potential redundant invoice against the sixth criteria analyzed by the redundant invoice reporting tool or program. If the current invoice is determined to be a potential redundant invoice, then the redundant invoice reporting tool or program outputs (in step 324) the potential invoice to section 6 of the redundancy report. However, if an invoice being investigated is determined not to be a potential redundant invoice, then the comparison process ends.

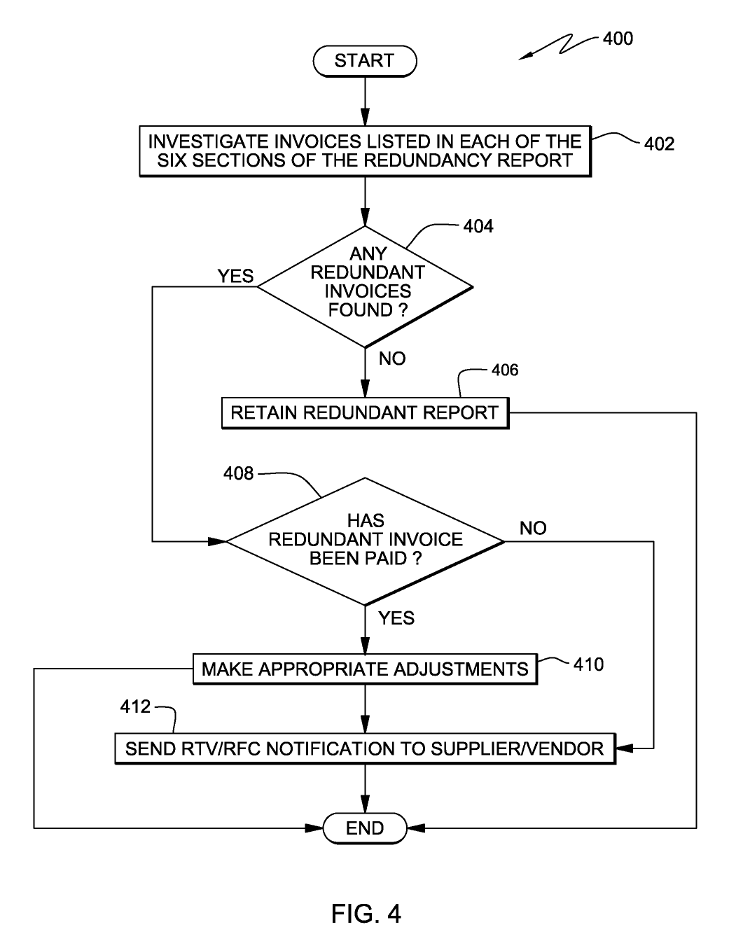

Turning to FIG. 4, reference numeral 400, outlines the verification process steps performed by an accounts payable invoice processor, in accordance with an embodiment of the invention. Once the redundant invoice reporting tool or program prints or displays a list containing potential redundant invoices, the list is investigated in step 402 by a person, namely, an accounts payable invoice processor, for determining whether or not a redundant invoice actually exists within the ERP system. A determination is made in step 404 as to whether or not any redundant invoices are found by the redundant invoice reporting tool or program. If not redundant invoices are determined to be found in step 404, the report is retained in step 406, ending the verification process. However, if in step 404, one or more redundant invoices are found in the redundancy or redundant report, a determination is made in step 408 as to whether or not the redundant invoice has been paid. If a determination is made that the redundant invoice has been paid, then in step 410, appropriate adjustments are made within the ERP system, ending the process. Going back to step 408, if a determination is made in step 408 that the redundant invoice has not been paid, then the ERP system begins in step 412 the process of either sending a RTV (Return to Vendor) notification or a RFC (Request for Credit) notification to the supplier or vendor, ending the process. In an embodiment, the accounts payable processor completes the appropriate RTV (Return to Vencor) or RFC (Request for Credit) form provided by the ERP system and sends the notification to the supplier or vendor.

Furthermore, in yet another embodiment, the invention provides a computer system for identifying redundant invoices. The computer system includes a central processing unit, first program instructions to input a plurality of invoices into an accounts payable electronic computer system, the first program instructions including instructions to group, as a group, invoices that have a similar vendor name, second program instructions to execute an algorithm on the accounts payable electronic computer system for identifying one or more redundant invoices among a current group of invoices chosen from the plurality of invoices inputted into the accounts payable electronic computer system, In an embodiment, the algorithm identifies the one or more redundant invoices among the plurality of invoices using each of six redundancy criteria searched by the algorithm and third program instructions to output a perceptible report containing respective separate sections corresponding to each of the six redundancy criteria analyzed by the algorithm for identifying the one or more redundant invoices among the current group of invoices inputted into the accounts payable electronic computer system, In an embodiment, an invoice reported on a respective section is not reported on another respective section of the perceptible report. In an embodiment, the first program instructions include instructions to load the algorithm onto the accounts payable electronic computer system, to select a history start date and a current start date for choosing the current group of invoices from the plurality of invoices inputted, to group, as a group, suppliers having a similar name and to create additional indexes for sorting the invoice data contained in the invoice table in the accounts payable electronic computer system. In an embodiment, the second program instructions include instructions to execute the algorithm on the accounts payable electronic computer system in real time. In an embodiment, the second program instructions include instructions to execute the algorithm on the accounts payable electronic computer system in batch mode. In an embodiment, the six redundancy criteria analyzed by the algorithm for searching the accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number. In an embodiment, the six redundancy criteria analyzed by the algorithm for searching the accounts payable electronic computer system consists essentially of same supplier invoice number and same amount, supplier reference numbers containing a reference number as a subset, redundant condensed supplier reference numbers, transposed supplier reference numbers and same supplier invoice number, invoice date and amount, with a different supplier number.

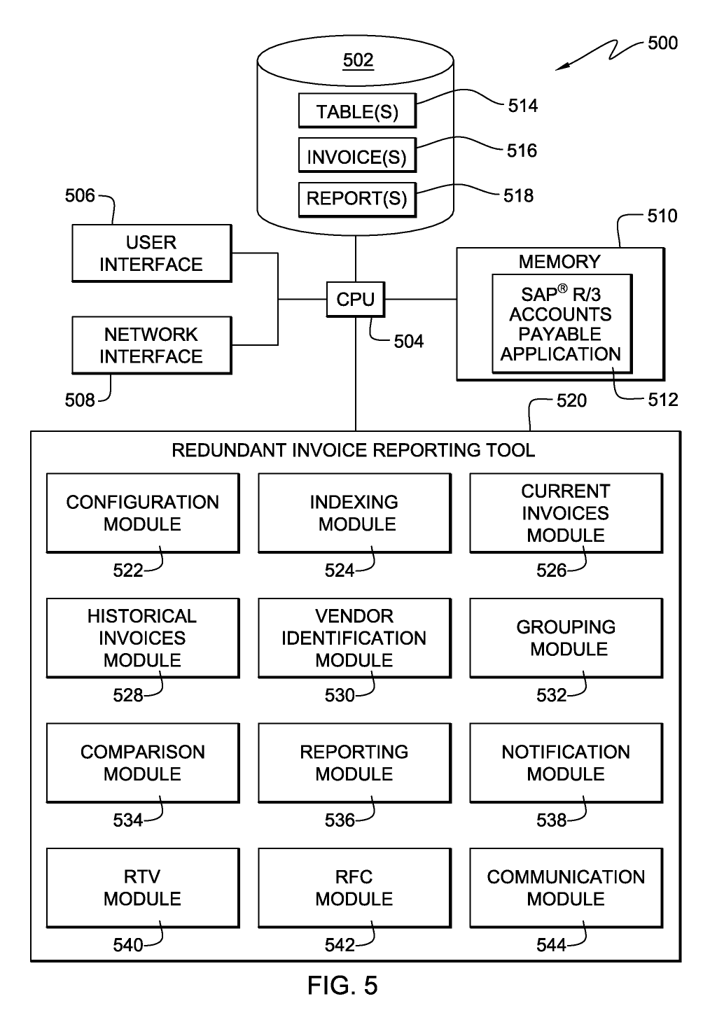

Reference is now made to FIG. 5, reference numeral 500, which depicts an embodiment of a computer system or server having deployed thereon a computer program product, namely, a redundant invoice reporting tool or program for identifying redundant invoices entered into an accounts payable electronic computer system, in accordance with an embodiment of the present invention. In an embodiment, the redundant invoice reporting tool or program 520 is run within the accounts payable electronic computer system or server 500. Preferably, the computer system 500 is a computer system or server that includes a central processing unit (CPU) 504, a local storage device 502, a user interface 506, a network interface 508 and a memory 510. The CPU 504 is configured generally to execute operations within the computer system/server 500. The user interface 506, in one embodiment, is configured to allow a user or operator to interact with the computer system or server 500, including allowing input of commands and/or data for executing the redundant invoice reporting tool or program for identifying redundant invoices among the invoices processed by the accounts payable electronic computer system 500. The network interface 508 is configured, in one embodiment, to facilitate network communications of the computer system or server 500 over a communications channel of a network. In an embodiment, the memory 510 is configured to store one or more applications or programs 512, such as, the commercially available SAP® Accounts Payable software application module, manufactured by SAP Aktiengesellschaft Joint Stock Company. In one embodiment, as shown in FIG. 5, the redundant invoice reporting tool or program 520 which runs on the accounts payable electronic computer system 500 comprises a logic unit that contains a plurality of modules configured to functionally execute the necessary steps of performing a search for identifying redundant invoices entered into the accounts payable electronic computer system 500. In an embodiment, shown in FIG. 5, the redundant invoice reporting tool or program 520 running on the ERP computer system 500 includes a configuration module 522, an indexing module 524, a current invoices module 526, a historical invoices module 528, a vendor identification linking module 530, a grouping module 532, a comparison module 534, a reporting module 536, a notification module 538, a RTV module 540, a RFC module 542 and a communication module 544. In an embodiment, the configuration module 522 is for selecting current invoices to be analyzed by the redundant invoice reporting tool or program 520. For instance, invoices falling within a certain date range, for example, invoices entered within the last couple of days through a current date) can be selected as the current date criteria for current invoices to be analyzed by the redundant invoice reporting tool or program 520 for identifying redundant invoices entered into the accounts payable electronic computer system. Further, historical invoices starting from a certain date, for example, Sep. 11, 2007 through a current date) can be selected as the historical date criteria for historical invoices to be analyzed by the redundant invoice reporting tool or program. Moreover, the mode of execution for running the redundant invoice reporting tool or program can be specified in the configuration module 522. For instance, the configuration module 522 can be set to run the redundant invoice reporting tool or program either in batch mode, that is, run the redundant invoice reporting tool or program over night, or in real time mode, that is, run the redundant invoice reporting tool or program in real time on the ERP or SAP system. The indexing module 524 is used to create new indexes for the one or more ERP tables 514 corresponding to the invoices 516 stored in the accounts payable electronic computer system, as discussed herein above in FIG. 2, reference numeral 204. In an embodiment, an index comprises of a set of one or more columns in a table. The new indexes enable the redundant invoice reporting tool or program to find and sort the information stored in the invoice tables within the ERP or SAP system more efficiently and in a faster time frame. The current invoices module 526 pulls information or data from the one or more invoice tables corresponding to the current invoice date criteria specified in the configuration module 522. The historical invoices module 528 pulls invoice information or data from the one or more invoice tables corresponding to the historical invoices date criteria specified in the configuration module 522. The vendor identification module 530 links vendor information or data obtained from a vendor table for linking the invoice table to the vendor table. In an embodiment, the redundant invoice reporting tool or program uses the vendor identification field index to link the invoice table to the vendor table to retrieve a vendor name for the current invoices and the historical invoices. The grouping module 532 creates vendor groups for the historical invoices by grouping together like vendor names into a vendor group. The comparison module 534 compares a current invoice to invoices identified as historical invoices using the six redundant criteria set forth in the redundant invoice reporting tool or program for identifying redundant invoices within the ERP system. The reporting module 536 writes to a redundant or redundancy report 518 a potential redundant invoice found that matches a first redundancy or redundant criteria among the six redundancy criteria that is searched in the invoice tables in the accounts payable electronic computer system. In an embodiment, the report 518 is stored in storage 502 within the accounts payable electronic computer system. In an embodiment, the report generated by the reporting module 536 is separated into six different sections corresponding to the six different redundancy criteria, with each section listing any invoices corresponding to invoices matching one of the six search criteria searched in the accounts payable electronic computer system, as discussed herein below with respect to FIG. 7. The notification module 538 notifies suppliers or vendors identified on the redundant report regarding redundant invoices found by the redundant invoice reporting tool or program 520 to have been entered in the accounts payable electronic computer system. In an embodiment, the RTV (Return-to-Vendor) module 540 initiates an external process of returning an invoice to a respective vendor or supplier identified on the invoice determined to be a redundant invoice in the accounts payable electronic computer system. Further, the RFC (Return-for-Credit) module 537 initiates an external process of reversing or returning an invoice for credit that has been entered into the accounts payable electronic computer system 500. The communication module 538 is configured to permit communication between the various modules of the redundant invoice reporting tool or program 520, memory 510, local storage 502 and with external computer systems, such as, other accounting systems that are connected to the accounts payable electronic computer system over a network.

In an embodiment, the invention provides a computer program product for identifying redundant invoices. The computer program product includes a computer readable medium, first program instructions to input data from a plurality of invoices into an invoice table residing within an accounts payable electronic computer system, second program instructions to execute an algorithm loaded onto the accounts payable electronic computer system for identifying one or more redundant invoices among a current group chosen from the plurality of invoices inputted into the accounts payable electronic computer system, In an embodiment, the algorithm identifies the redundant invoices among the current group of invoices chosen from the plurality of invoices using each of six redundancy criteria searched by the algorithm and third program instructions to output a perceptible report containing a separate section corresponding to each of the six redundancy criteria analyzed by the algorithm for identifying the one or more redundant invoices among the current group of invoices inputted into the accounts payable electronic computer system, In an embodiment, a redundant invoice that is reported in one section of the perceptible report is not reported in another section of the perceptible report and In an embodiment, the first, second and third program instructions are recorded on the computer readable medium. In an embodiment, the first program instructions include instructions to load the algorithm onto the accounts payable electronic computer system, to select a history start date and a current start date for choosing the current group of invoices from the plurality of invoices inputted, to group, as a group, suppliers having a similar name and to create additional indexes for sorting the invoice data contained in the invoice table in the accounts payable electronic computer system. In an embodiment, the second program instructions include instructions to execute the algorithm on the accounts payable electronic computer system in real time. In an embodiment, the second program instructions include instructions to execute the algorithm on the accounts payable electronic computer system in batch mode. In an embodiment, the six redundancy criteria analyzed by the algorithm for searching the accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number. In an embodiment, the six redundancy criteria analyzed by the algorithm for searching the accounts payable electronic computer system consists essentially of same supplier invoice number and same amount, supplier reference numbers containing a reference number as a subset, redundant condensed supplier reference numbers, transposed supplier reference numbers and same supplier invoice number, invoice date and amount, with a different supplier number.

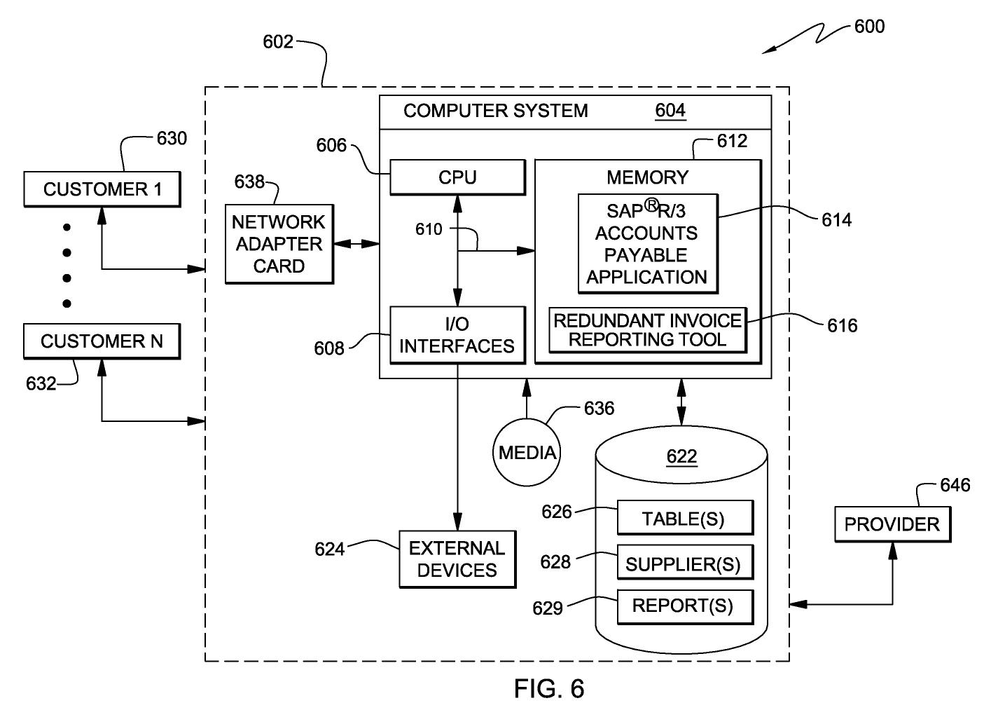

Referring now to FIG. 6, there is illustrated a system 600 within an infrastructure 602 that includes a server or computer system 604 that comprises an accounts payable electronic computer system that has deployed thereon an accounts payable application 614, such as the commercially available SAP® R/3 Accounts Payable software application, manufactured by SAP Aktiengesellschaft Joint Stock Company. Further, the computer system 604 has deployed thereon a computer program product, namely, the redundant invoice reporting tool or program 616, which implements the invention for performing a search for identifying redundant invoices entered into the computer system 604, in accordance with an embodiment of the present invention. In an embodiment, the computer system 604 has deployed thereon a computer program product, namely, the redundant invoice reporting tool or program 616, which implements the invention for performing a search for identifying redundant invoices, in accordance with an embodiment of the present invention. In an embodiment, the computer program product comprises a computer readable or computer-usable storage medium, which provides program code namely, the redundant invoice reporting tool or program 616, for use by or in connection with a computer server or computer system or any instruction execution system. The redundant invoice reporting tool or program 616 can be loaded into memory 612 of the computer system 604 from a computer readable storage medium or media reference numeral 636, such as, a magnetic tape or disk, optical media, DVD, memory stick, semiconductor memory, etc. or downloaded from the server via a network adapter card (reference numerals 638) installed on the system or server 604. As depicted in FIG. 6, system 600 includes a computer infrastructure 602, which is intended to represent any type of computer architecture that is maintained in a secure environment (i.e., for which access control is enforced). Further, as shown, infrastructure 602 includes a computer server or system 604 that typically represents an accounts payable server or computer system 604 or the like that includes a redundant invoice reporting tool or program 616. It should be understood, however, that although not shown, other hardware and software components (e.g., additional computer systems, routers, firewalls, etc.) could be included in infrastructure 602.

In general, the computer system 604 is connected via a network to infrastructure 602. The computer system 604 includes the redundant invoice reporting tool or program 616 that is run on the computer system 604 for identifying redundant invoices entered into the computer system 604 using the accounts payable electronic application 614. Further, as shown in FIG. 6, the computer system 604 can communicate with one or more customers, customer 1 (reference numeral 630) through customer N (reference numeral 632) that subscribe through a provider (reference numeral 646) to receive a service of identifying redundant invoices entered into the accounts payable application 614.

For instance, a customer (customer 1) at computer system or server 630 can interface with infrastructure 602 in order to run a redundant invoice check using the redundant invoice reporting tool or program 616 loaded into the local memory 612 of the computer system 604. The redundant invoice reporting tool or program 616 can be loaded into the local memory 612 of the computer system 604 from a computer readable storage medium or media reference numeral 636, such as, a magnetic tape or disk, optical media, DVD, memory stick, semiconductor memory, etc. or downloaded from the server via a network adapter card (reference numerals 638) installed on the respective system or server 604. It should be understood that under the present invention, infrastructure 602 could be owned and/or operated by a party such as provider 646, or by an independent entity. Regardless, use of infrastructure 602 and the teachings described herein could be offered to one or more customers on a subscription or fee-basis.

The computer system or server 604 is shown to include a CPU (hereinafter “processing unit 606”), a memory 612, a bus 610 and input/output (I/O) interfaces 608. Further, the server 604 is shown in communication with external I/O devices/resources 620 and storage system 622. In general, processing unit 606 executes computer program code stored in memory 612, such as the commercially available SAP® Accounts Payable software application module, manufactured by SAP Aktiengesellschaft Joint Stock Company. In an embodiment, the redundancy reports 629 generated by the redundant invoice reporting tool or program 616 are stored in local storage 622 within infrastructure 602. Further, the one or more invoice tables 626 investigated by the redundant invoice reporting tool or program 616 are stored in storage 622. In an embodiment, a list of the one or more supplier(s) or vendor(s) 628 from whom invoices are received are stored in storage 622. While executing the redundant invoice reporting tool or program 616 on the computer system or server 604, the processing unit 606 can read and/or write data, to/from memory 612, storage system 622 and/or I/O interfaces 608, such as, the redundancy reports 629 stored in storage 622, which are generated by running the redundant invoice reporting tool or program 616 on computer system 604. Alternatively, the redundant invoice reporting tool or program 616 may store the redundancy reports 629 in memory 612. Bus 610 provides a communication link between each of the components in computer system 600, such that information can be communicated within the infrastructure 602. External devices 624 can comprise any devices (e.g., keyboard, pointing device, display, etc.) that enable a user to interact with computer system 600 and/or any devices (e.g., network card, modem, etc.) that enable computer system 604 to communicate with one or more other computing devices, such as, systems 630 and/or 632.

Computer infrastructure 602 is only illustrative of various types of computer infrastructures for implementing the invention. For example, in one embodiment, computer infrastructure 602 may comprise two or more server groups or clusters that communicate over a network to perform the various process steps of the invention. Moreover, computer system 600 is only representative of various possible computer systems that can include numerous combinations of hardware. To this extent, in other embodiments, computer system 600 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 606 may comprise a single processing unit, or be distributed across one or more processing units in one or more locations, e.g., on a client and server. Similarly, memory 612 and/or storage system 622 can comprise any combination of various types of data storage and/or transmission media that reside at one or more physical locations. Further, I/O interfaces 608 can comprise any system for exchanging information with one or more external devices 624. Still further, it is understood that one or more additional components (e.g., system software, math co-processing unit, etc.) not shown in FIG. 6 can be included in computer system 600.

Storage system 622 can be any type of system (e.g., a database) capable of providing storage for information under the present invention. To this extent, storage systems 622 could include one or more storage devices, such as a magnetic disk drive or an optical disk drive. In another embodiment, systems 622 include data distributed across, for example, a local area network (LAN), wide area network (WAN) or a storage area network (SAN) (not shown). Although not shown, additional components, such as cache memory, communication systems, system software, etc., may be incorporated into computer system 600.

In yet another embodiment, the invention provides a process for deploying computing infrastructure comprising integrating computer-readable code into a computing system, where the code in combination with the computing system is capable of performing a process for identifying redundant invoices. The process comprises providing an accounts payable electronic computer system, inputting, invoice data obtained from a plurality of invoices, into an invoice table residing on the accounts payable electronic computer system, executing an algorithm on the accounts payable electronic computer system for identifying one or more redundant invoices among a current group of invoices chosen from the plurality of invoices inputted into the accounts payable electronic computer system, where the algorithm identifies the redundant invoices among the current group of invoices chosen from the plurality of invoices using each of six redundancy criteria searched by the algorithm and outputting a perceptible report containing a separate section corresponding to each of the six redundancy criteria analyzed by the algorithm for identifying the one or more redundant invoices inputted into the accounts payable electronic computer system, In an embodiment, a redundant invoice that is reported in one section of the perceptible report is not reported in another section of the perceptible report. In an embodiment, the six redundancy criteria analyzed by the algorithm for searching the accounts payable electronic computer system consists essentially of same supplier invoice number and same amount, supplier reference numbers containing a reference number as a subset, redundant condensed supplier reference numbers, transposed supplier reference numbers and same supplier invoice number, invoice date and amount, with a different supplier number.

Reference is now made to FIGS. 7A-7F, which show an example of a redundancy report generated by the redundant invoice reporting tool that is executed on an accounts payable electronic computer system for identifying redundant invoices entered into the accounts payable electronic computer system, in accordance with embodiments of the invention. Turning to FIG. 7A, reference numeral 700A depicts an outputted perceptible report with examples of redundant invoices found by the redundant invoice reporting tool or program using the first redundant criteria. In an embodiment, for the first redundant criteria, the redundant invoice reporting tool or program searches the invoice table for same supplier invoice date (as shown by reference numeral 703 in FIG. 7A) and amount (reference numeral 704 in FIG. 7A). Further, in an embodiment, the redundant invoice reporting tool or program searches the invoice table for same supplier invoice reference number (as shown by reference numeral 702 in FIG. 7A) and invoice date (reference numeral 703 in FIG. 7A). Furthermore, in an embodiment, the redundant invoice reporting tool or program searches the invoice table for same supplier invoice reference number (as shown by reference numeral 702 in FIG. 7A) and amount (reference numeral 704 in FIG. 7A). After matching invoices in the invoice table against the first criteria, the redundant invoice reporting tool or program searches the invoice table for the second redundant criteria, namely, supplier or vendor reference numbers that contain a reference number as a subset. As shown in the example of FIG. 7B, reference numeral 700B, shows potential invoices (reference numeral 705) matching this second redundancy criteria of the redundancy report shown in FIG. 7B). In particular, a supplier or vendor reference number may contain a reference number that is a subset, for example, “TEST11” versus “TEST” and, as such, the invoice would be outputted to this section of the redundancy report. After matching invoices in the invoice table against the second criteria, the redundant invoice reporting tool or program searches the invoice table for the third redundant criteria, namely, redundant condensed supplier reference numbers (redundant criteria 3). For instance, the redundant invoice reporting tool or program identifies redundant invoices having the same prefix, namely, “1563” (reference numeral 706 in FIG. 7C) in this section. After the redundant invoice reporting tool or program has completed searching the third criteria, the redundant invoice reporting tool or program searches the fourth criteria and identifies supplier or vendor reference numbers (reference numeral 708) that do not have the same length (redundant criteria 4). As shown in FIG. 7D, reference numeral 700D, examples of redundant invoices found to have supplier or vendor reference numbers (reference numeral 708) that do not have the same length (redundant criteria 4), for instance, “TEST DR/CR 2” versus “TEST DRCR 3” (reference numeral 708) are shown or listed in this section of the redundancy report. In particular, the redundant invoice reporting tool or program takes into consideration prefixes, suffixes, embedded characters and/or the possibility that the numbers are transposed. Further, after the redundant invoice reporting tool or program has completed searching the fifth criteria, the redundant invoice reporting tool or program identifies invoices having supplier or vendor reference numbers are transposed (redundant criteria 5) as shown in FIG. 7E, reference numeral 700E. For instance, FIG. 7E shows examples of invoices found by the redundant invoice reporting tool or program where the supplier or vendor reference numbers are transposed (reference numeral 710). After the redundant invoice reporting tool or program has completed searching the fifth criteria, the redundant invoice reporting tool or program drops the vendor grouping (reference numeral 320 as discussed in FIG. 3) and identifies invoices having the same invoice reference number (reference numeral 712), the same date (reference numeral 714) and amount (reference numeral 716), irrespective of the supplier (redundant criteria 6). As such, FIG. 7F, reference numeral 700F, depicts examples of redundant invoices found to have the same invoice reference (reference numeral 712), same date (reference numeral 714) and same amount (reference numeral 716), but with different suppliers, namely, Tandberg Television Ltd (reference numerals 718) and Andrew Lucas Photography (reference numeral 720). As shown, an invoice reported or written to one section is not reported or written to another section of the report.

Accordingly, when the redundancy program runs, it is run against vendor invoices stored in standard SAP tables based on a history start date selected until the current start date. If the redundant invoice reporting tool or program finds a match on one of the six criteria, it will stop and write it to the report under the section that matches the criteria. In other words, the same invoice will not be on the report multiple times as a potential redundant invoice. The invoice will only be listed or reported on the redundancy report against the first criteria of the six criteria when a redundant invoice is found matching a respective first criteria among the six criteria that is run in a consecutive fashion. The redundant invoice reporting tool or program has fuzzy logic capability, which enables the redundant invoice reporting tool or program to drop prefixes, suffixes, look for condensed, truncated or transposed characters, embedded characters, such as, invoice number “1234” versus invoice number “234”, as explained herein above with respect to FIGS. 7A through 7F.

The foregoing descriptions of specific embodiments of the present invention have been presented for the purpose of illustration and description. They are not intended to be exhaustive or to limit the invention to the precise forms disclosed and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of identifying redundant invoices, said method comprising:
providing an accounts payable electronic computer system comprising an invoice table that contains invoice data inputted from a plurality of invoices entered into said accounts payable electronic computer system;
executing an algorithm with said accounts payable electronic computer system for identifying one or more redundant invoices among a current group of invoices chosen from said plurality of invoices inputted into said accounts payable electronic computer system, wherein said algorithm identifies said redundant invoices among said current group of invoices chosen from said plurality of invoices using each of six redundancy criteria analyzed by said algorithm; and
outputting a perceptible report containing a separate section corresponding to each of said six redundancy criteria analyzed by said algorithm for identifying said one or more redundant invoices among said current group of invoices inputted into said accounts payable electronic computer system, wherein a redundant invoice that is reported in one section of said perceptible report is not reported in another section of said perceptible report.

2. A method according to claim 1, wherein said providing step further comprises:
selecting a history start date and a current start date for choosing said current group of invoices from said plurality of invoices inputted;
grouping, as a group, suppliers having a similar name; and
creating additional indexes for sorting said invoice data contained in said invoice table in said accounts payable electronic computer system.

3. A method according to claim 2, wherein said executing step further comprises:
loading said algorithm onto said accounts payable electronic computer system; and
executing said algorithm on said accounts payable electronic computer system in real time.

4. A method according to claim 2, wherein said executing step further comprises:
loading said algorithm onto said accounts payable electronic computer system; and
executing said algorithm on said accounts payable electronic computer system in batch mode.

5. A method according to claim 4, wherein said six redundancy criteria analyzed by said algorithm for searching said accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.

6. A computer system for identifying redundant invoices, comprising:
a central processing unit;
first program instructions to input a plurality of invoices into an accounts payable electronic computer system, said first program instructions including instructions to group, as a group, invoices that have a similar vendor name;
second program instructions to execute an algorithm on said accounts payable electronic computer system for identifying one or more redundant invoices among a current group of invoices chosen from said plurality of invoices inputted into said accounts payable electronic computer system, wherein said algorithm identifies said one or more redundant invoices among said plurality of invoices using each of six redundancy criteria searched by said algorithm; and
third program instructions to output a perceptible report containing respective separate sections corresponding to each of said six redundancy criteria analyzed by said algorithm for identifying said one or more redundant invoices among said current group of invoices inputted into said accounts payable electronic computer system, wherein an invoice reported on a respective section is not reported on another respective section of said perceptible report and wherein said first, second and third program instructions are stored on said computer system for execution by said central processing unit.

7. A computer system according to claim 6, wherein said first program instructions include instructions to load said algorithm onto said accounts payable electronic computer system, to select a history start date and a current start date for choosing said current group of invoices from said plurality of invoices inputted, to group, as a group, suppliers having a similar name and to create additional indexes for sorting said invoice data contained in said invoice table in said accounts payable electronic computer system.

8. A computer system according to claim 7, wherein said second program instructions include instructions to execute said algorithm on said accounts payable electronic computer system in real time.

9. A computer system according to claim 7, wherein said second program instructions include instructions to execute said algorithm on said accounts payable electronic computer system in batch mode.

10. A computer system according to claim 8, wherein said six redundancy criteria analyzed by said algorithm for searching said accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.

11. A computer program product for identifying redundant invoices, said computer program product comprising:
a computer readable medium;
first program instructions to input data from a plurality of invoices into an invoice table residing within an accounts payable electronic computer system;
second program instructions to execute an algorithm loaded onto said accounts payable electronic computer system for identifying one or more redundant invoices among a current group chosen from said plurality of invoices inputted into said accounts payable electronic computer system, wherein said algorithm identifies said redundant invoices among said current group of invoices chosen from said plurality of invoices using each of six redundancy criteria searched by said algorithm; and
third program instructions to output a perceptible report containing a separate section corresponding to each of said six redundancy criteria analyzed by said algorithm for identifying said one or more redundant invoices among said current group of invoices inputted into said accounts payable electronic computer system, wherein a redundant invoice that is reported in one section of said perceptible report is not reported in another section of said perceptible report and wherein said first, second and third program instructions are recorded on said computer readable medium.

12. A computer program product according to claim 11, wherein said first program instructions include instructions to load said algorithm onto said accounts payable electronic computer system, to select a history start date and a current start date for choosing said current group of invoices from said plurality of invoices inputted, to group, as a group, suppliers having a similar name and to create additional indexes for sorting said invoice data contained in said invoice table in said accounts payable electronic computer system.

13. A computer program product according to claim 12, wherein said second program instructions include instructions to execute said algorithm on said accounts payable electronic computer system in real time.

14. A computer program product according to claim 12, wherein said second program instructions include instructions to execute said algorithm on said accounts payable electronic computer system in batch mode.

15. A computer program product according to claim 12, wherein said six redundancy criteria analyzed by said algorithm for searching said accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.

16. A method of identifying redundant invoices, said method comprising:
providing an accounts payable electronic computer system that comprises an invoice table for inputting invoice data obtained from a plurality of invoices;
inputting said plurality of invoices into said invoice table on said accounts payable electronic computer system;
executing an algorithm on said accounts payable electronic computer system for identifying one or more redundant invoices among a current group chosen from said plurality of invoices inputted into said accounts payable electronic computer system, wherein said algorithm identifies said redundant invoices among said plurality of invoices using each of six redundancy criteria searched by said algorithm; and
outputting a perceptible report containing a separate section for each of said six redundancy criteria searched by said algorithm for identifying said one or more redundant invoices among said current group of invoices inputted into said accounts payable electronic computer system, wherein a redundant invoice that is reported in one section of said perceptible report is not reported in another section of said perceptible report.

17. A method according to claim 16, wherein said providing step further comprises:
selecting a history start date and a current start date for choosing said current group of invoices from said plurality of invoices inputted;
grouping, in a group, suppliers having a similar name; and
creating additional indexes for sorting said invoice data contained in said invoice table in said accounts payable electronic computer system.

18. A method according to claim 17, wherein said executing step further comprises:
executing said algorithm on said accounts payable electronic computer system in real time.

19. A method according to claim 17, wherein said executing step further comprises:
executing said algorithm on said accounts payable electronic computer system in batch mode.

20. A method according to claim 17, wherein said six redundancy criteria analyzed by said algorithm for searching said accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.

21. A process for deploying computing infrastructure comprising integrating computer-readable code into a computing system, wherein said code in combination with said computing system is capable of performing a process for identifying redundant invoices, said process comprising:
providing an accounts payable electronic computer system;
inputting, invoice data obtained from a plurality of invoices, into an invoice table residing on said accounts payable electronic computer system;
executing an algorithm on said accounts payable electronic computer system for identifying one or more redundant invoices among a current group of invoices chosen from said plurality of invoices inputted into said accounts payable electronic computer system, wherein said algorithm identifies said redundant invoices among said current group of invoices chosen from said plurality of invoices using each of six redundancy criteria searched by said algorithm; and
outputting a perceptible report containing a separate section corresponding to each of said six redundancy criteria analyzed by said algorithm for identifying said one or more redundant invoices inputted into said accounts payable electronic computer system, wherein a redundant invoice that is reported in one section of said perceptible report is not reported in another section of said perceptible report.

22. The process according to claim 21, wherein said providing step further comprises:
selecting a history start date and a current start date for choosing said current group of invoices from said plurality of invoices inputted;
grouping, in a group, suppliers having a similar name; and
creating additional indexes for sorting said invoice data contained in said invoice table in said accounts payable electronic computer system.

23. The process according to claim 22, wherein said executing step further comprises:
loading said algorithm onto said accounts payable electronic computer system; and
executing said algorithm on said accounts payable electronic computer system in real time.

24. The process according to claim 22, wherein said executing step further comprises:
loading said algorithm onto said accounts payable electronic computer system; and
executing said algorithm on said accounts payable electronic computer system in batch mode.

25. The process according to claim 23, wherein said six redundancy criteria analyzed by said algorithm for searching said accounts payable electronic computer system comprises of: same supplier invoice number and same amount, supplier reference numbers containing a reference number as a subset, redundant condensed supplier reference numbers, transposed supplier reference numbers and same supplier invoice number, invoice date and amount, with a different supplier number.
